(19) United States
(12) Patent Application Publication
(10) Pub. No.: US 2012/0134726 A1
(43) Pub. Date: May 31, 2012

(54) Image Forming Apparatus

(75) Inventor: Yoshiya TOMATSU, Kasugai-shi (JP)

(73) Assignee: Brother Kogyo Kabushiki Kaisha, Nagoya-shi (JP)

(21) Appl. No.: 13/303,640

(22) Filed: Nov. 23, 2011

(30) Foreign Application Priority Data
Nov. 25, 2010 (JP) 2010-262459

(51) Int. Cl. G03G 15/00

(52) U.S. Cl. 399/361

(57) ABSTRACT

An image forming unit includes an elastic roller that rotates in contact with a recording medium to apply a force thereto, a rigid roller disposed facing the elastic roller and that contacts the recording medium, and a pressing device that applies pressing force to each end of the elastic roller or the rigid roller in an axial direction to press one of the elastic roller and the rigid roller against the other. The elastic roller includes a straight roller portion disposed in a specified region extending from a center of the elastic roller toward each end of the elastic roller in the axial direction, and taper roller portions that sandwich the straight roller portion in the axial direction. Each taper roller portion has an outside diameter decreasing from an outer end of the straight roller portion toward an outer end of the elastic roller in the axial direction.

### CROSS REFERENCE TO RELATED APPLICATION

This application claims priority from Japanese Patent Application No. 2010-262459, filed on Nov. 25, 2010, the entire subject matter of which is incorporated herein by reference.

### FIELD

Aspects of the disclosure relate to an image forming apparatus configured to form an image on a recording medium.

### BACKGROUND

A known image forming apparatus includes registration rollers made up of a metal roller and a rubber roller. The rubber roller is a crowned roller whose outside diameter is smaller from the center toward both ends in an axial direction.

In the image forming apparatus, a sheet feeding speed depends on a circumferential velocity of the rubber roller, which is a drive roller. The outside diameter or diameter size of the rubber roller is changing in the axial direction, and there is a high possibility that a deformation amount of the rubber roller at each of the center and both ends in the axial direction varies from product to product. Thus, the sheet feeding speed may greatly vary depending on each product, resulting in wide variance in the sheet feeding speed.

If the variance in the sheet feeding speed is wide, a sheet feeding speed calculated at design stage may differ from an actual sheet feeding speed. As a time to start image formation may greatly differ from a time calculated at design stage, an image may be formed on a recording medium with its size expanding or shrinking in the sheet feeding direction, and image quality may be degraded.

### SUMMARY

Aspects of the disclosure provide an image forming apparatus configured to feed a recording medium reliably for stable high-quality image formation.

According to an aspect of the disclosure, an image forming apparatus comprises an image forming unit, an elastic roller, a rigid roller, and a pressing device. The image forming unit is configured to form an image on a recording medium. The elastic roller includes a peripheral surface made of an elastic material, and is configured to rotate and make contact with the recording medium to apply a force to the recording medium. The rigid roller includes a peripheral surface made of a rigid material. The rigid roller is disposed facing the elastic roller and configured to contact the recording medium. The pressing device is configured to apply pressing force to the elastic roller or the rigid roller to press one of the elastic roller and the rigid roller against the other. The elastic roller includes a straight roller portion and taper roller portions. The straight roller portion is disposed in a specified region extending in an axial direction of the elastic roller. The straight roller portion has an outside diameter including a maximum outside diameter of the elastic roller. The taper roller portions are disposed to sandwich the straight roller portion therebetween in the axial direction. Each of the taper roller portions has an outside diameter decreasing from an outer end of the straight roller portion toward an outer end of the elastic roller in the axial direction.

### BRIEF DESCRIPTION OF THE DRAWINGS

Illustrative aspects will be described in detail with reference to the following figures in which like elements are labeled with like numbers and in which:

FIG. 1 is a side sectional view of an internal structure of an image forming apparatus using features described herein;

FIG. 2 illustrates an elastic roller and a rigid roller when a pressing force acts on the elastic roller;

FIG. 3 illustrates the elastic roller and the rigid roller when no pressing force acts on the elastic roller;

FIG. 4 illustrates that the elastic roller and the rigid roller are deformed; and

FIG. 5 illustrates distribution of a contact pressure applied to the elastic roller in the axial direction.

### DETAILED DESCRIPTION

An illustrative embodiment will be described in detail with reference to the accompanying drawings. An image forming apparatus according to aspects of the disclosure applies to an electrophotographic-type image forming apparatus.

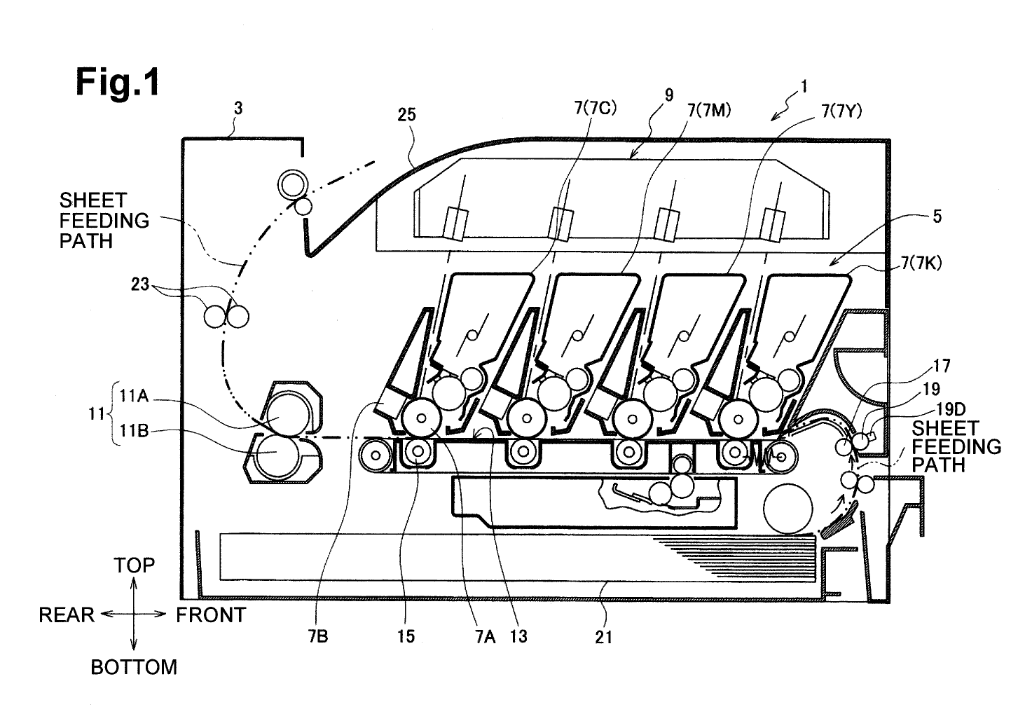

A general structure of an illustrative image forming apparatus 1 will be described with reference to FIG. 1.

For ease of discussion, in the following description, the top or upper side, the bottom or lower side, the left or left side, the right or right side, the front or front side, and the rear or rear side are used to define the various parts when the image forming apparatus 1 is disposed in an orientation in which it is intended to be used. In FIG. 1, the right side is referred to as the front or front side, the left side is referred to as the rear or the rear side, the up side is referred to as the top or upper side, and the down side is referred to as the bottom or lower side.

As shown in FIG. 1, the image forming apparatus 1 includes, in a main body 3, an image forming unit 5. The image forming unit 5 is of an electrophotographic type, and is configured to form an image on a recording medium, e.g., plain paper and transparency sheets, (hereinafter referred to as a sheet) by transferring a developer image onto the recording medium. The image forming unit 5 includes process cartridges 7, an exposure unit 9, and a fixing unit 11.

As the image forming apparatus 1 is of direct transfer tandem type, the process cartridges 7, e.g., four process cartridges 7 in this embodiment, are arranged in line along a sheet feeding direction (in a front-rear direction in this embodiment).

Specifically, the four process cartridges 7 are a black process cartridge 7K, a yellow process cartridge 7Y, a magenta process cartridge 7M, and a cyan process cartridge 7C, which are arranged in this order from an upstream side in the sheet feeding direction.

The process cartridges 7K, 7Y, 7M, and 7C are identical in structure but different in color of developer. Each process cartridge 7 includes a photosensitive drum 7A configured to carry a developer image thereon, and a charger 7B configured to charge a surface of the photosensitive drum 7A. In FIG. 1, the photosensitive drum 7A and the charger 7B are marked in the process cartridge 7C only due to space limitation.

The exposure unit 9 is configured to expose surfaces of the photosensitive drums 7A, which are charged by the respective chargers 7B, so that electrostatic latent images are formed on the surfaces of the photosensitive drums 7A. The electrostatic latent images formed on the surfaces of the photosensitive drums 7A are supplied with charged developer and developer images are carried or formed on the surfaces of the photosensitive drums 7A.

Transfer rollers 15 are disposed in positions facing the photosensitive drums 7A, via a belt 13 configured to feed a sheet thereon. The transfer rollers 15 are configured to transfer the developer images carried on the photosensitive drums 7A onto a sheet to be fed by the belt 13. The transfer rollers 15 are subjected to voltage application to transfer the developer images carried on the photosensitive drums 7A onto the sheet.

The fixing unit 11 includes a heat roller 11A and a pressure roller 11B. The heat roller 11A is disposed on a downstream side of the belt 13 in the sheet feeding direction and configured to heat a sheet while feeding it to the downstream side. The pressure roller 11B is configured to press the sheet against the heat roller 11A and rotate following the movement of the sheet.

The developer images carried on the photosensitive drums 7A are transferred onto the sheet fed by the belt 13. The sheet having the developer images transferred thereto is fed to the fixing unit 11 and the developer images are thermally fixed to the sheet in the fixing unit 11.

A pair of registration rollers 17, 19 is disposed on an upstream side of the belt 13 in the sheet feeding direction or near an inlet of the image forming unit 5. The registration rollers 17, 19 are configured to correct skew of a sheet entering the image forming unit 5 and adjust a time to feed the sheet into the image forming unit 5. The registration rollers 17, 19 are configured to contact the sheet from both sides relative to thickness of the sheet in such a manner that the registration rollers 17, 19 sandwich the sheet therebetween.

The registration rollers 17, 19 stop or reverse their rotation to hold the sheet to correct skew, and then rotate in the normal direction at a specified timing to start feeding the sheet to the belt 13 or the image forming unit 5.

The image forming unit 5 starts image formation to the sheet at the time that the registration rollers 17, 19 start to feed the sheet to the belt 13. The sheet is fed such that the center of the sheet in the width direction is aligned with the center of the image forming unit 5 in the width direction.

The structure of the registration rollers will be described.

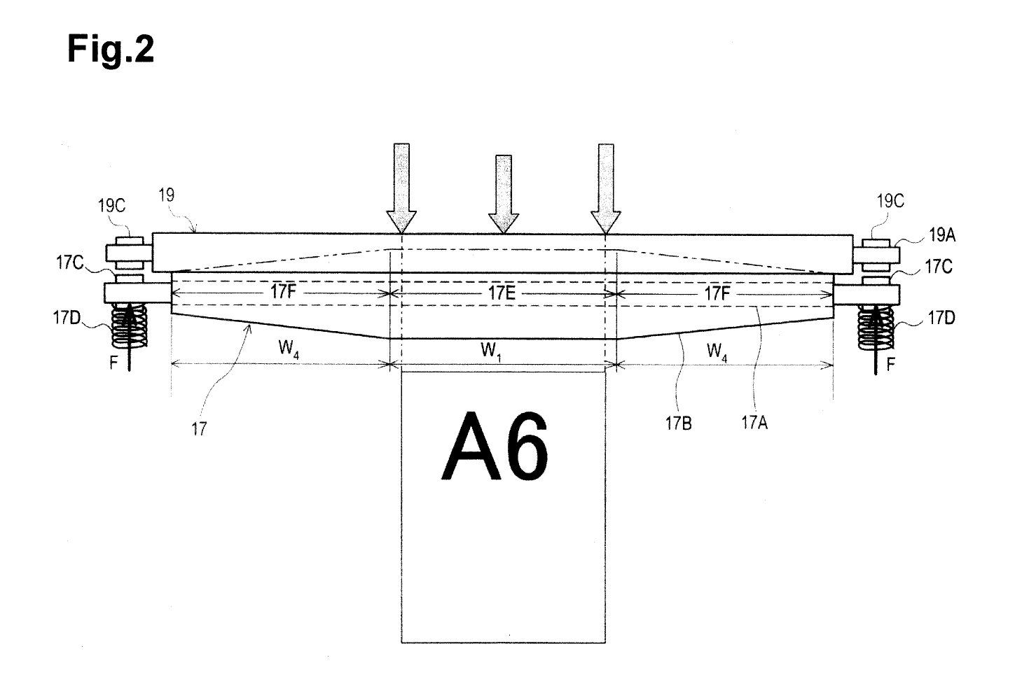

As shown in FIG. 2, the pair of registration rollers includes an elastic roller 17 and a rigid roller 19.

The elastic roller 17 includes a shaft 17A made of metal, e.g., a free-cutting steel (SUM; JIS standard) and a roller portion 17B made of a deformable material having a high coefficient of friction, e.g., rubber. The elastic roller 17 is formed by fixing, e.g., bonding, the roller portion 17B around an outer surface of the shaft 17A. The elastic roller 17 is configured to rotate to apply a force to a sheet contacting the roller portion 17B.

Hereinafter, the elastic roller 17 refers to the roller portion 17B because the roller portion 17B contacts a sheet, except where specifically noted.

The elastic roller 17 is rotatably supported by a frame, which constitutes a part of the apparatus body and is not shown, via bearings 17 disposed on both ends of the shaft 17A in its longitudinal direction. The bearings 17C are movably coupled to the frame in a direction perpendicular to the axial direction of the rigid roller 19. Thus, the elastic roller 17 is configured to move in the direction close to or away from the rigid roller 19.

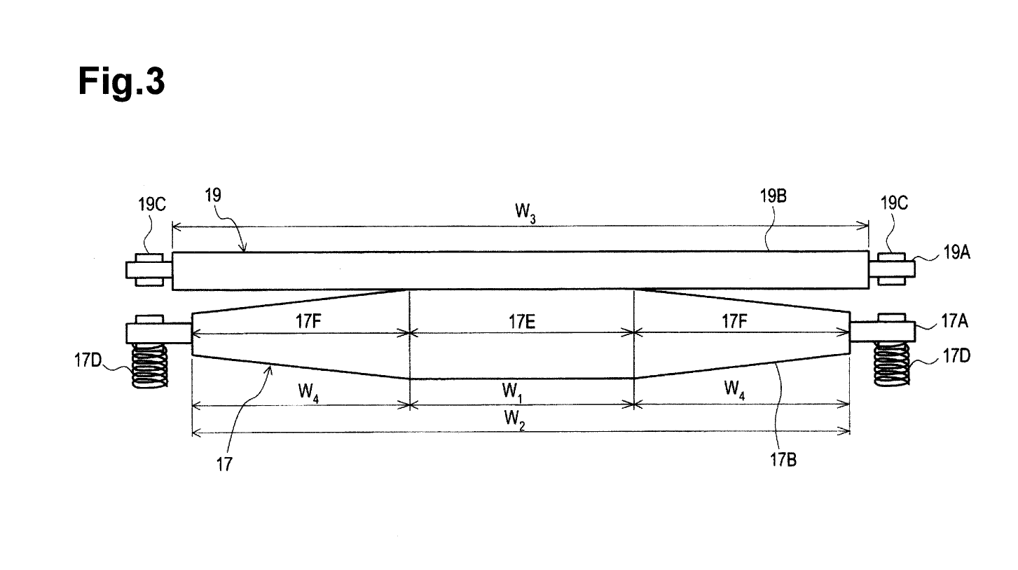

The bearings 17C are normally pressed toward the rigid roller 19 by springs 17D as an example of a pressing device. Thus, both ends of the elastic roller 17 in its axial direction are normally subjected to pressing force F for pressing the elastic roller 17 toward the rigid roller 19. Thus, as shown in FIG. 3, when the pressing force F disappears, the roller portion 17B having elastically deformed returns to its original state, and it is clear that the elastic roller 17 is an end-relieved roller with two taper end portions on each end in the axial direction.

Specifically, the roller portion 17B of the elastic roller 17 includes a straight roller portion 17E and taper roller portions 17F, which are connected with each other. The straight roller portion 17E is disposed in a specified region extending from center toward both ends in the axial direction. The taper roller portions 17F are disposed on both ends of the straight roller portion 17E in the axial direction. In the taper roller portions 17F, the outside diameter decreases toward edge.

The straight roller portion 17E has an axial dimension W1, which is greater than or equal to half of a minimum sheet width of the recording sheets which can be fed by the registration rollers 17, 19 and smaller than a maximum sheet width of the recording sheets which can be fed by the registration rollers 17, 19.

The width direction refers to a direction perpendicular to the sheet feeding direction and thickness direction of a sheet. The elastic roller 17 and the rigid roller 19 rotate to feed sheets. Thus, in this illustrative embodiment, the width direction agrees with the axial direction.

In this illustrative embodiment, the minimum sheet width is 105 mm, which is the shorter dimension of A6 size (105 mm×148 mm) and the maximum sheet width is 220 mm, which is the longer dimension of DL size (110 mm×220 mm). The dimension W1 of the straight roller portion 17E is assigned to approximately 50% to 115% of the shorter dimension of A6 size such that the dimension W1 of the straight roller portion 17E is greater than or equal to half of the shorter dimension of A6 size and smaller than or equal to half of the longer dimension of DL size.

Preferably, the dimension W1 of the straight roller portion 17E is in the range of 25%-55% of an axial dimension W2 of the roller portion 17B. More preferably, it is in the range of 40%-50%.

The rigid roller 19 is disposed facing the elastic roller 17. The rigid roller 19 includes a shaft 19A made of metal, e.g., a free-cutting steel (SUM; JIS standard) and a roller portion 19B made of metal, which is not elastically deformed, e.g., aluminum in this embodiment.

Hereinafter, the rigid roller 19 refers to the roller portion 19B because the roller portion 19B contacts a sheet, except where specifically noted.

The roller portion 19B of the rigid roller 19 has an axial dimension W3, which is greater than the axial dimension W2 of the roller portion 17B of the elastic roller 17. The rigid roller 19 is a flat roller whose outside diameter is uniform in the axial direction.

The rigid roller 19 is rotatably supported by the frame via bearings 19C disposed on both ends of the shaft 19A in its longitudinal direction. The bearings 19C are fixedly coupled to the frame.

As shown in FIG. 2, when the elastic roller 17 is pressed toward the rigid roller 19 by the springs 17D, the straight roller portion 17E and the taper roller portions 17F of the elastic roller 17 become elastically deformed, and the roller portion 17B of the elastic roller 17 contacts the roller portion 19B of the rigid roller 19 in the axial direction.

The rigid roller 19 is configured to contact a first side, e.g. front side, of a sheet on which an image is to be formed, while the elastic roller 17 is configured to contact a second side opposite to the first side, e.g. a back side, of the sheet. In this embodiment, the rigid roller 19 is configured to collect foreign substances, e.g. paper dust, adhered to the front side of the sheet before the sheet enters the image forming unit 5.

An outer circumferential surface of the roller portion 19B of the rigid roller 19, which contacts the sheet, may be covered with fluorine coating. The outer circumferential surface covered with fluorine coating contacts a paper dust removing pad 19D (FIG. 1). In this embodiment, the paper dust removing pad 19D contacts the roller portion 19B in the axial direction of the rigid roller 19.

The paper dust removing pad 19D is fixed to the frame. When the rigid roller 19 rotates, the paper dust removing pad 19D slidingly and frictionally contacts the outer circumferential surface of the roller portion 19B, and the rigid roller 19 is charged with static electricity, which attracts paper dust adhered on a sheet to the rigid roller 19. The paper dust attracted to the rigid roller 19 is removed and collected by the paper dust removing pad 19D.

As shown in FIG. 3, the elastic roller 17 includes the straight roller portion 17E whose outside diameter is uniform in a specified region extending from the center of the elastic roller 17 toward both ends, and the taper roller portions 17F disposed on both ends of the straight roller portion 17E and whose outside diameter decreases toward ends in the axial direction.

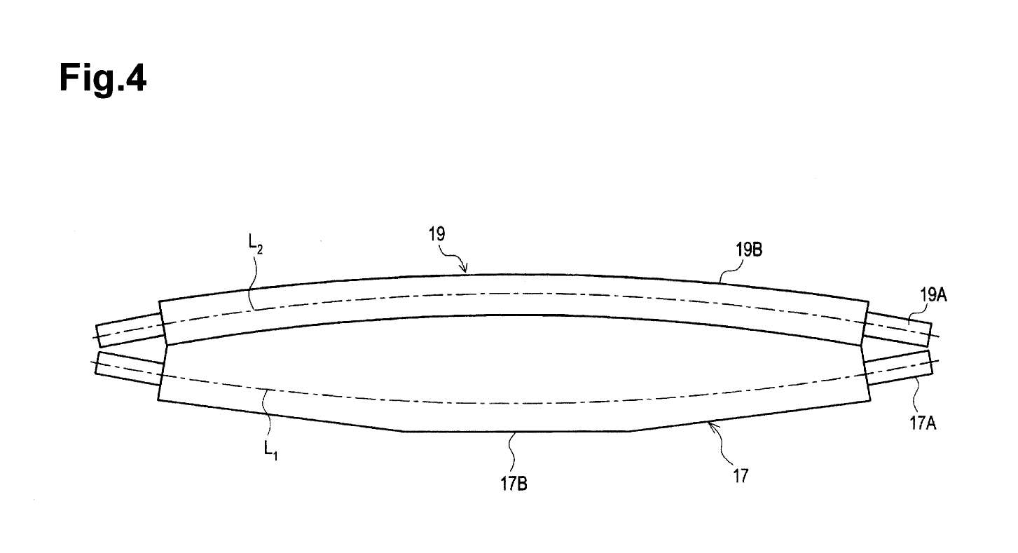

When the pressing force F produced by the springs 17D acts on the elastic roller 17, as shown in FIG. 4, the elastic roller 17 and the rigid roller 19 are oppositely deformed such that an axis L1 of the elastic roller 17 and an axis L2 of the rigid roller 19 are curved oppositely and are the farthest away from each other at their center in the axial direction. In FIG. 4, the deformation of the elastic roller 17 and the rigid roller 19 depicted is exaggerated for illustrative purposes. The actual amount of deformation is small.

If the elastic roller 17 has a uniform outside diameter in the axial direction, contact pressure between the elastic roller 17 and the rigid roller 19 may be irregularly distributed in the axial direction so that the contact pressure is the smallest at the center and increases toward both ends in the axial direction. Thus, the elastic roller 17 and the rigid roller 19 cannot nip a sheet uniformly in the width direction.

In the image forming apparatus 1 according to this illustrative embodiment, a sheet whose width is small, e.g., an A6 sized sheet in portrait orientation, is to be fed in a central portion of the elastic roller 17 and the rigid roller 19, in which the contact pressure becomes the smallest, in the axial direction. In the above case where the elastic roller 17 has a uniform outside diameter in the axial direction, the contact pressure becomes the smallest in the central portion where the sheet is to be fed. Thus, as feeding pressure between the elastic roller 17 and the rigid roller 19 becomes insufficient, there is a high possibility that the elastic roller 17 and the rigid roller 19 can not stably feed a small-sized sheet.

However, in this embodiment, the straight roller portion 17E having the maximum outside diameter of the elastic roller 17 is disposed in the central portion of the elastic roller 17 in the axial direction where the elastic roller 17 is deformed maximally. This structure can reduce the potential of the contact pressure in the central portion in the axial direction from lowering, even when the elastic roller 17 and the rigid roller 19 are oppositely deformed such that the axes L1 and L2 are curved oppositely and are the farthest away from each other in the central portion in the axial direction.

The outside diameter of the straight roller portion 17E and a taper rate or angle of each of the taper roller portion 17F is set such that the elastic roller 17 from end to end in the axial direction contacts the rigid roller 19 in the axial direction when the elastic roller 17 is subjected to the pressing force F.

As the contact pressure between the elastic roller 17 and the rigid roller 19 is substantially uniform in the axial direction, the elastic roller 17 and the rigid roller 19 can nip a sheet stably in the width direction.

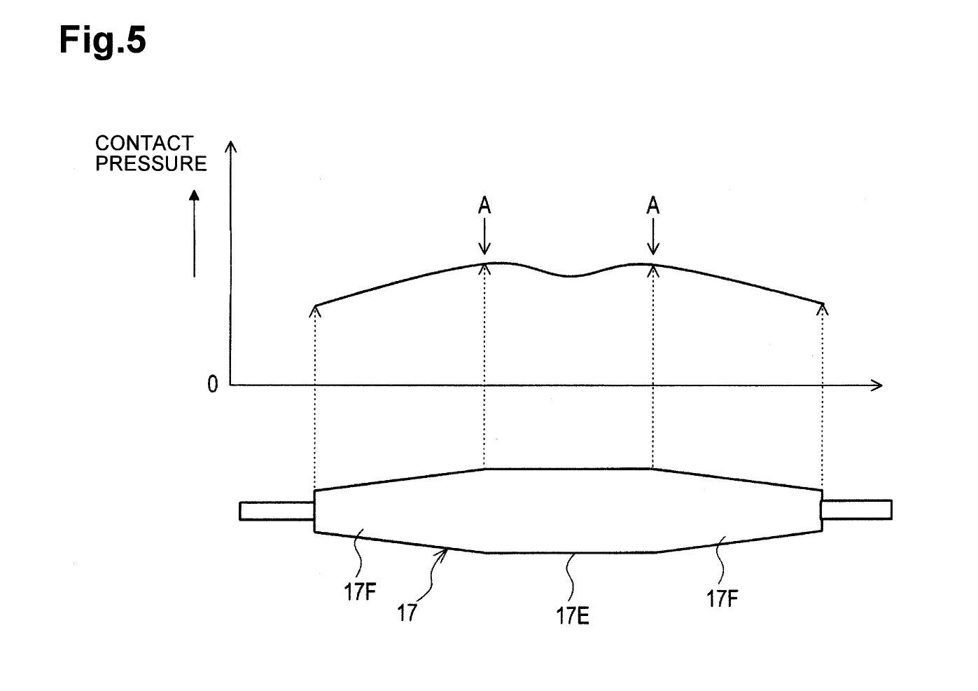

Further, as the straight roller portion 17E has a uniform outside diameter, a circumferential velocity at the straight roller portion 17E becomes uniform in any place in the axial direction and the average contact pressure at the straight roller portion 17E becomes greater than that at each of the taper roller portions 17F (FIG. 5). This feature can reduce product-to-product variation of a sheet feeding speed, which may greatly vary depending on the circumferential velocity of the straight roller portion 17E.

Thus, a discrepancy between a sheet feeding speed calculated at design stage and an actual sheet feeding speed is small, which reduces the potential that a time to start image formation greatly differs from a time calculated at design stage. As a result, the potential of expanding or shrinking an image to be formed on a sheet in the sheet feeding direction can be reduced so that an image may be formed without its quality being degraded.

In this embodiment, the elastic roller 17 and the rigid roller 19 are deformed such that axis L1 of the elastic roller 17 and the axis L2 of the rigid roller 19 are curved oppositely and are the farthest apart from each other at the central portion in the axial direction. However, the straight roller portion 17E is disposed in a specified region of the elastic roller 17 from the central portion toward both ends. As shown in FIG. 5, in the straight roller portion 17E, the contact pressure becomes slightly greater at both ends (near points A in FIG. 5) than at the central portion.

In the known image forming apparatus disclosed in the related art, the rubber roller is not provided with the straight roller portion 17E, and the outside diameter of the rubber roller decreases from the center to the edge in the axial direction. In the rubber roller, the contact pressure tends to become a maximum in the central portion in the axial direction. Thus, in the related art, the registration rollers nip a sheet mainly at one point in the central portion in the axial (width) direction.

Thus, the above art has a high possibility that a sheet is easily fed skewed. However, in this embodiment, as a sheet is fed while being nipped near both ends (near points A in FIG. 5) of the straight roller portion 17E or at two points in the axial direction, the potential of skewed feeding of the sheet can be reduced, resulting in more stable sheet feeding.

As described above, in this illustrative embodiment, sheets can be fed stably and thus stable high-quality image formation can be achieved.

In addition, the dimension W1 of the straight roller portion 17E is set to be smaller than half of the maximum sheet width, and thus the straight roller portion 17E contacts a sheet having the minimum sheet width entirely in the width direction. Thus, even a small-sized sheet, e.g., an A6 sized sheet in portrait orientation, can be stably fed.

If the dimension W1 of the straight roller portion 17E is set to be approximately 105% to 115% of the minimum sheet width or greater than the minimum sheet width, a sheet having the minimum sheet width can be more stably fed.

As described above, when the pressing force F produced by the springs 17D acts on the elastic roller 17, the elastic roller 17 and the rigid roller 19 are deformed such that the axes L1 and L2 are curved oppositely and are the farthest apart from each other at the central portion in the axial direction as shown in FIG. 4. To distribute the contact pressure substantially uniformly, it is necessary to provide the taper portions 17E on both ends in the axial direction.

However, if the dimension W1 of the straight roller portion 17E is great and the dimension W4 of each of the taper roller portions 17F is excessively small, the distribution of the contact pressure may be substantially identical to that in a case where the elastic roller 17 has a uniform outside diameter in the axial direction. Thus, the contact pressure may be irregularly distributed in a range where the elastic roller 17 contacts the sheet.

To distribute the contact pressure substantially uniformly, it is necessary to increase the dimension W4 of each of the taper roller portions 17F, which may lead to upsizing of the dimensions W2 and W3 of the registration rollers 17 and 19.

In this embodiment, the dimension W1 of the straight roller portion 17E is smaller than the maximum sheet width of the recording sheets which can be fed by the registration rollers 17, 19. Thus, the potential for upsizing the dimensions W2 and W3 of the registration rollers 17 and 19 can be reduced, and the contact pressure in the range where the sheet contacts the elastic roller 17 can be substantially uniformly distributed.

In this embodiment, the dimension W3 of the rigid roller 19 is greater than the dimension W2 of the elastic roller 17 and the outside diameter of the rigid roller 19 is unchanged in the axial direction.

Thus, the rigid roller 19 according to this embodiment can be manufactured with a reduced cost compared with a case where the rigid roller 19 is end-relieved. As a result, the image forming apparatus 1 can be manufactured with reduced cost, as well as achieving stable high-quality image formation.

It is preferable that the rigid roller 19 has a uniform outside diameter in the axial direction to improve the function of the rigid roller 19 for removing substances adhered or produced on the surface of a sheet. In this embodiment, the rigid roller 19 has a uniform outside diameter in the axial direction, and thus effectively removes the substances from the surface of the sheet.

In other words, if the rigid roller 19 is end-relieved, it will be difficult to cause the rigid roller 19 to slide on the paper dust removing pad 19D stably, and thus it will be difficult to make full use of the function of the rigid roller 19 to remove foreign substances. However, as the rigid roller 19 has a uniform outside diameter in the axial direction in this embodiment, the rigid roller 19 can effectively fulfill its function of removing the foreign substances.

In this embodiment, the registration rollers 17 and 19 are disposed in front of an inlet of the image forming unit 5, the rigid roller 19 is configured to rotate in contact with a surface of a sheet, and the paper dust removing pad 19D is configured to remove foreign substances adhered to the surface of the rigid roller 19. Thus, the rigid roller 19 can effectively fulfill its function of removing the foreign substances.

If the rigid roller 19 is movable toward the elastic roller 17, the rigid roller 19 may move in response to thickness of a sheet. Thus, it may be difficult to cause the rigid roller 19 to slide on the paper dust removing pad 19D stably.

In other words, to cause the rigid roller 19 to slide on the paper dust removing pad 19D stably in the above case, the paper dust removing pad 19D should be movable in response to moving of the rigid roller 19. However, it may be very difficult to cause the paper dust removing pad 19D which is movable to remove the foreign substances adhered to the surface of the rigid roller 19 adequately.

In this embodiment, the springs 17D is configured to apply the pressing force F to each end of the elastic roller 17 in the axial direction, and the elastic roller 17 is movable toward the rigid roller 19, which is stationary. With this structure, the substance adhered to the rigid roller 19 can be easily removed.

This illustrative embodiment shows, but is not limited to, the direct-tandem, electrophotographic type for the image forming unit. It will be appreciated that this embodiment also applies to other types, an intermediate transfer type, four-cycle type, monochrome electrophotographic type, and inkjet type as well.

This illustrative embodiment shows, but is not limited to, the elastic roller 17 and the rigid roller 19 as the registration rollers. The elastic roller and the rigid roller may be applied to a pair of rollers 23 (FIG. 1) configured to feed a sheet ejected from the fixing unit 11 toward an output tray 25 (FIG. 1).

This illustrative embodiment shows, but is not limited to, coil springs as a pressing device. The pressing device may include torsion coil springs, leaf springs, and rubbers.

This illustrative embodiment shows, but is not limited to, the rigid roller having a function of removing paper dust.

This illustrative embodiment shows, but is not limited to, the elastic roller configured to move relative to the rigid roller. The rigid roller may be configured to move relative to the elastic roller.

While the features herein have been described in connection with various example structures and illustrative aspects, it will be understood by those skilled in the art that other variations and modifications of the structures and aspects described above may be made without departing from the scope of the inventions described herein. Other structures and aspects will be apparent to those skilled in the art from a consideration of the specification or practice of the features disclosed herein. It is intended that the specification and the described examples only are illustrative with the true scope of the inventions being defined by the following claims.

What is claimed is:

1. An image forming apparatus comprising:
an image forming unit configured to form an image on a recording medium;
an elastic roller including a peripheral surface made of an elastic material, the elastic roller being configured to rotate and make contact with the recording medium to apply a force to the recording medium;
a rigid roller including a peripheral surface made of a rigid material, the rigid roller being disposed facing the elastic roller and configured to contact the recording medium; and
a pressing device configured to apply pressing force to the elastic roller or the rigid roller to press one of the elastic roller and the rigid roller against the other,
wherein the one of the elastic roller and the rigid roller that receives the pressing force from the pressing device is configured to move relative to the other, and
wherein the elastic roller includes:
a straight roller portion disposed in a specified region extending in an axial direction of the elastic roller, the straight roller portion having an outside diameter including a maximum outside diameter of the elastic roller; and
taper roller portions disposed to sandwich the straight roller portion therebetween in the axial direction, each taper roller portion having an outside diameter decreasing from an outer end of the straight roller portion toward an outer end of the elastic roller in the axial direction.

2. The image forming apparatus according to claim 1, wherein the outside diameter of the straight roller portion is uniform in the axial direction.

3. The image forming apparatus according to claim 1, wherein the straight roller portion and the taper roller portions are connected with each other.

4. The image forming apparatus according to claim 1, wherein an axial dimension of the straight roller portion is in a range of 25%-55% of an axial dimension of the elastic roller.

5. The image forming apparatus according to claim 1, wherein the axial dimension of the straight roller portion is in a range of 40%-50% of the axial dimension of the elastic roller.

6. The image forming apparatus according to claim 1, wherein an axial dimension of the straight roller portion is greater than or equal to half of a minimum sheet width of the recording medium that is able to be fed by the elastic roller and the rigid roller.

7. The image forming apparatus according to claim 1, wherein an axial dimension of the straight roller portion is smaller than a maximum sheet width of the recording medium that is able to be fed by the elastic roller and the rigid roller.

8. The image forming apparatus according to claim 1, wherein an axial dimension of the straight roller portion is smaller than half of a maximum sheet width of the recording medium that is able to be fed by the elastic roller and the rigid roller.

9. The image forming apparatus according to claim 1,
wherein an axial dimension of the rigid roller is greater than an axial dimension of the elastic roller, and
wherein the rigid roller has a uniform outside diameter in the axial direction.

10. The image forming apparatus according to claim 1,
wherein the elastic roller and the rigid roller are disposed in front of an inlet of the image forming unit,
wherein the rigid roller is configured to rotate and make contact with a side of the recording medium on which an image is to be formed, and
wherein the image forming apparatus further comprises a substance removing device configured to remove foreign substance adhering to a surface of the rigid roller.

11. The image forming apparatus according to claim 1, wherein the elastic roller and the rigid roller are configured to correct skew of the recording medium before the recording medium enters the image forming unit and to adjust a time at which the recording medium enters the image forming unit.

12. The image forming apparatus according to claim 1, wherein the pressing device is configured to apply a pressing force to each end of the elastic roller in the axial direction.

13. The image forming apparatus according to claim 12, wherein the elastic roller from end to end in the axial direction is configured to contact the rigid roller in the axial direction when the elastic roller is subjected to the pressing force.

14. The image forming apparatus according to claim 1, wherein the specified region extends from a center of the elastic roller toward each end of the elastic roller in the axial direction.
